(19) United States
(12) Patent Application Publication
(10) Pub. No.: US 2025/0198508 A1
(43) Pub. Date: Jun. 19, 2025

(54) SHIFT DEVICE

(71) Applicant: KABUSHIKI KAISHA TOKAI-RIKA-DENKI-SEISAKUSHO, Aichi (JP)

(72) Inventors: Hironori WATANABE, Niwa-gun, Aichi (JP); Hironori MIZUNO, Niwa-gun, Aichi (JP); Norihiro YAMAMURA, Niwa-gun, Aichi (JP); Takuya SASAKI, Niwa-gun, Aichi (JP); Yoya OGAWA, Niwa-gun, Aichi (JP)

(73) Assignee: KABUSHIKI KAISHA TOKAI-RIKA-DENKI-SEISAKUSHO, Aichi (JP)

(21) Appl. No.: 18/842,955

(22) PCT Filed: Feb. 27, 2023
(86) PCT No.: PCT/JP2023/007160

§ 371 Date: Aug. 30, 2024

(30) Foreign Application Priority Data
Mar. 4, 2022 (JP) 2022-033886

(51) Int. Cl. F16H 59/10

(52) U.S. Cl. CPC F16H 59/105

(57) ABSTRACT

In a shift device, a lever is turned to rotate a magnet. Furthermore, a magnetic sensor detects a magnetic field generated by the magnet on a detection surface to detect a rotational position of the magnet. Here, when the lever is disposed at a “D” position, a left parallel surface of the magnet faces the detection surface in parallel. Therefore, a variation in the magnetic field of the magnet on the detection surface can be suppressed, detection accuracy of the rotational position of the magnet by the magnetic sensor can be increased, and detection accuracy of the “D” position of the lever can be increased.

### TECHNICAL FIELD

The present invention relates to a shift device in which a shift body is moved to change a shift position of the shift body.

### BACKGROUND ART

In a gear selection system described in DE 102018220662 A, a gear selection lever is turned to turn a magnet. Furthermore, a sensor device detects a magnetic field generated by the magnet to detect a turning position of the magnet and to detect a shift position of the gear selection lever.

Here, in the gear selection system device, a surface of the magnet facing the sensor device is curved.

### SUMMARY OF INVENTION

### Technical Problem

In view of the above fact, an object of the present invention is to obtain a shift device capable of increasing detection accuracy of a shift position of a shift body.

### Solution to Problem

A shift device according to a first aspect of the present invention includes: a shift body that is moved to change a shift position; a magnet that has a parallel surface and that is moved by movement of the shift body; and a detection unit that has a detection surface in which a position of the magnet facing the detection surface is changed by movement of the magnet and that detects a magnetic field generated by the magnet on the detection surface to detect a movement position of the magnet and to detect a shift position of the shift body, the parallel surface facing the detection surface in parallel when the shift body is disposed at a first shift position.

A shift device according to a second aspect of the present invention is the shift device according to the first aspect of the present invention, in which the parallel surface serves as a magnetic pole of the magnet.

A shift device according to a third aspect of the present invention is the shift device according to the first or second aspect of the present invention, in which a center between magnetic poles of the magnet faces the detection surface when the shift body is disposed at a second shift position.

A shift device according to a fourth aspect of the present invention is the shift device according to any one of the first to third aspects of the present invention, in which movement of the magnet is amplified with respect to movement of the shift body.

A shift device according to a fifth aspect of the present invention is the shift device according to any one of the first to fourth aspects of the present invention, further including a link mechanism that transmits movement from the shift body to the magnet.

### Advantageous Effects of Invention

In the shift device according to the first aspect of the present invention, the shift body is moved to change a shift position of the shift body. In addition, the magnet is moved by movement of the shift body to change a position of the magnet facing the detection surface of the detection unit. Furthermore, the detection unit detects a magnetic field generated by the magnet on the detection surface to detect a movement position of the magnet and to detect a shift position of the shift body.

Here, when the shift body is disposed at the first shift position, the parallel surface of the magnet faces the detection surface of the detection unit in parallel. Therefore, a variation in the magnetic field of the magnet on the detection surface of the detection unit can be suppressed, detection accuracy of a movement position of the magnet by the detection unit can be increased, and detection accuracy of the first shift position of the shift body can be increased.

In the shift device according to the second aspect of the present invention, the parallel surface of the magnet serves as a magnetic pole of the magnet. Therefore, when the shift body is disposed at the first shift position, a variation in the magnetic field of the magnet on the detection surface of the detection unit can be effectively suppressed.

In the shift device according to the third aspect of the present invention, when the shift body is disposed at the second shift position, the center between the magnetic poles of the magnet faces the detection surface of the detection unit. Therefore, a variation in the magnetic field of the magnet on the detection surface of the detection unit can be suppressed, detection accuracy of a movement position of the magnet by the detection unit can be increased, and detection accuracy of the second shift position of the shift body can be increased.

In the shift device according to the fourth aspect of the present invention, movement of the magnet is amplified with respect to movement of the shift body. Therefore, a movement amount of the magnet with respect to a movement amount of the shift body can be increased, and detection accuracy of a movement position of the shift body based on a movement position of the magnet can be increased.

In the shift device according to the fifth aspect of the present invention, the link mechanism transmits movement from the shift body to the magnet. Therefore, the movement can be transmitted from the shift body to the magnet with a simple structure.

### BRIEF DESCRIPTION OF DRAWINGS

FIG. 1A is a perspective view illustrating a shift device according to an embodiment of the present invention as viewed from a left oblique rear side.

FIG. 1B is a perspective view illustrating the shift device according to the embodiment of the present invention as viewed from an upper oblique left side.

FIG. 2A is a perspective view illustrating a main part of the shift device according to the embodiment of the present invention as viewed from a left oblique rear side.

FIG. 2B is a perspective view illustrating the main part of the shift device according to the embodiment of the present invention as viewed from a left oblique front side.

FIG. 3A is a perspective view illustrating a rotating body, a link, and a magnet of the shift device according to the embodiment of the present invention as viewed from a rear oblique left side.

FIG. 3B is a front view illustrating the rotating body, the link, and the magnet of the shift device according to the embodiment of the present invention as viewed from a front.

FIG. 3C is a perspective view illustrating a fixed frame of the rotating body of the shift device according to the embodiment of the present invention as viewed from a left oblique front side.

FIG. 3D is a perspective view illustrating a piece of the rotating body of the shift device according to the embodiment of the present invention as viewed from a rear oblique left side.

FIG. 4A is a front view illustrating a state where a lever is disposed at a “D” position as viewed from a front in the shift device according to the embodiment of the present invention.

FIG. 4B is a front view illustrating a state where the lever is disposed at an “H” position as viewed from a front in the shift device according to the embodiment of the present invention.

FIG. 4C is a front view illustrating a state where the lever is disposed at an “R” position as viewed from a front in the shift device according to the embodiment of the present invention.

### DESCRIPTION OF EMBODIMENTS

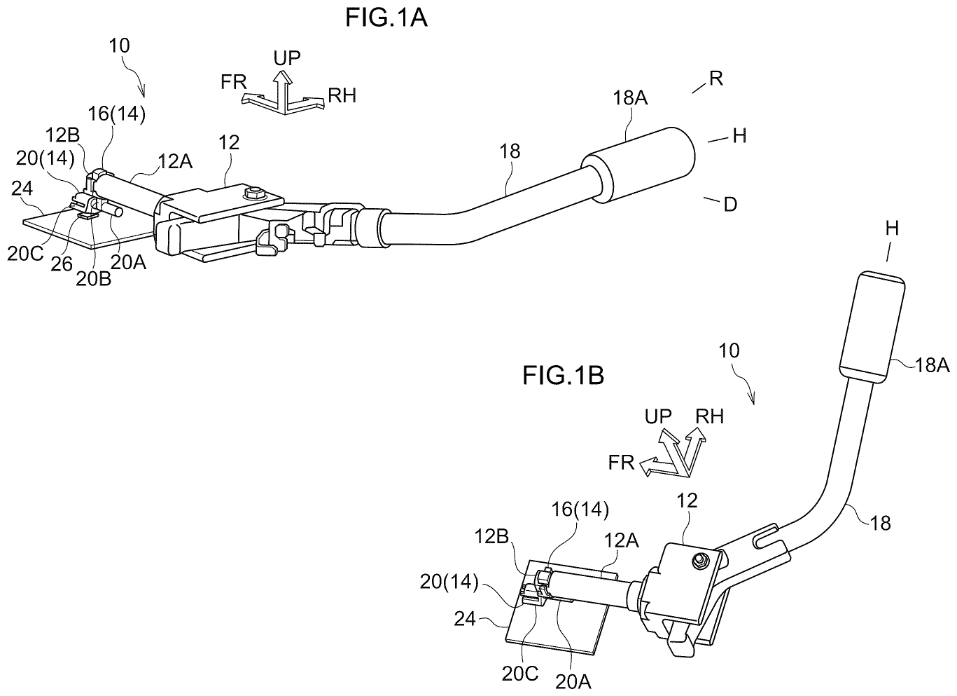

FIG. 1A illustrates a perspective view of a shift device 10 according to an embodiment of the present invention as viewed from a left oblique rear side, and FIG. 1B illustrates a perspective view of the shift device 10 as viewed from an upper oblique left side. Note that, in the drawings, a front side of the shift device 10 is indicated by an arrow FR, a right side of the shift device 10 is indicated by an arrow RH, and an upper side of the shift device 10 is indicated by an arrow UP.

The shift device 10 according to the present embodiment is disposed in a steering column (not illustrated) of a vehicle (automobile), and a front side, a right side, and an upper side of the shift device 10 are directed to a front side, a right side, and an upper side of the vehicle, respectively.

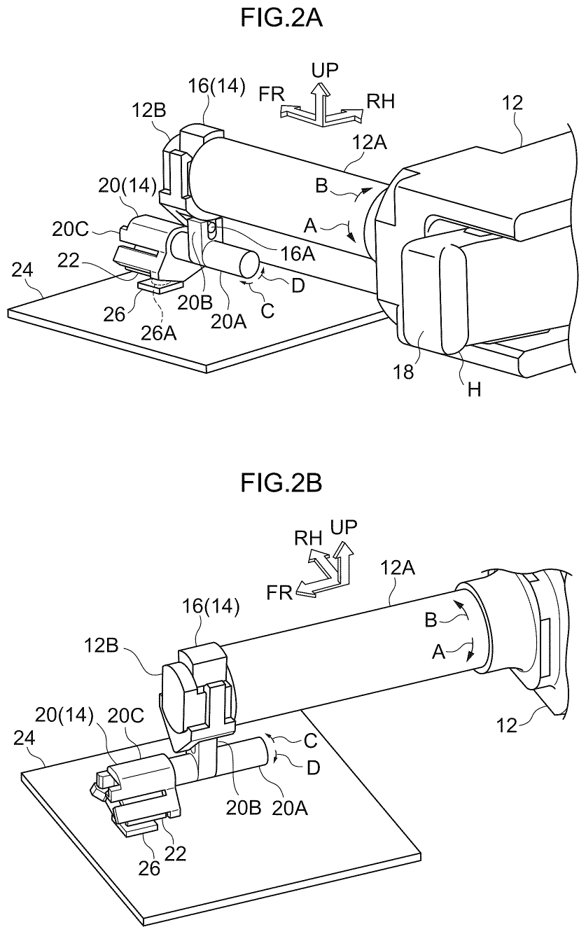

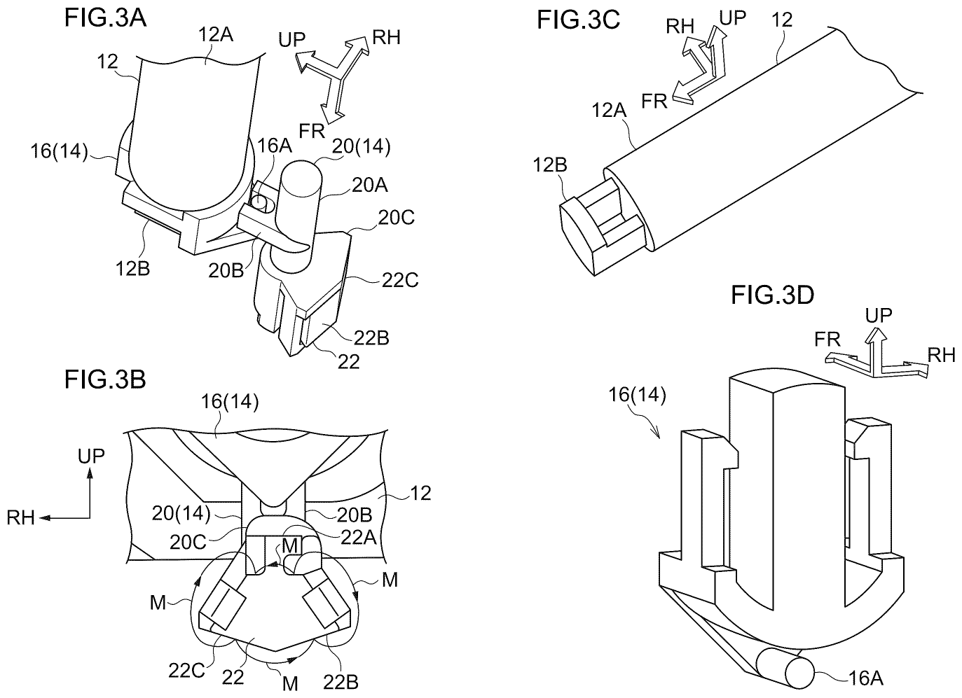

As illustrated in FIGS. 1A and 1B, the shift device 10 includes a rotating body 12 (see FIGS. 2A and 2B), and a columnar rotating shaft 12A is disposed at a front portion of the rotating body 12. An axial direction of the rotating shaft 12A is a front-rear direction, and the rotating body 12 is supported so as to be rotatable about the rotating shaft 12A as a central axis. A U-shaped fixed frame 12B (see FIG. 3C) is integrally disposed on a front side of the rotating shaft 12A, and the inside of the fixed frame 12B is opened in an up-down direction.

A piece 16 (see FIGS. 3A and 3D) having a substantially E-shaped cross section as a connecting portion constituting a link mechanism 14 is attached to the fixed frame 12B of the rotating body 12, and a lower wall of the piece 16 is disposed below the fixed frame 12B, and movement of the piece 16 upward with respect to the fixed frame 12B is locked. A central portion of the piece 16 is extended upward from the lower wall of the piece 16 and has a rectangular columnar shape. The central portion of the piece 16 is fitted into the fixed frame 12B, and movement of the piece 16 in a front-rear direction and a left-right direction with respect to the fixed frame 12B is locked. A left portion and a right portion of the piece 16 are extended upward from the lower wall of the piece 16, and hook portions are formed at upper end portions of the left portion and the right portion. The hook portions of the left portion and the right portion of the piece 16 are hooked on a left portion and a right portion of the fixed frame 12B, respectively, and movement of the piece 16 downward with respect to the fixed frame 12B is locked. As a result, the piece 16 is fixed to the fixed frame 12B and integrally rotated with the rotating body 12. A lower end portion of the piece 16 protrudes downward from a front end portion of the lower wall of the piece 16, and a columnar connection shaft 16A is integrally disposed at the lower end portion of the piece 16 and extended rearward.

A proximal end portion (front end portion) of a substantially rod-shaped lever 18 as a shift body is connected to a rear portion of the rotating body 12, and the lever 18 can be turned (moved) integrally with the rotating body 12 about the rotating shaft 12A as a central axis. An intermediate portion of the lever 18 is extended in a direction toward a rear side as it goes to a right side, and a distal end side portion (rear side portion) of the lever 18 is extended to the right side. A substantially columnar knob 18A as a grip portion is disposed at a distal end portion of the lever 18, and the knob 18A is disposed in a vehicle interior. An occupant (in particular, a driver) of the vehicle can perform a turning operation on the lever 18 upward and downward in the knob 18A. The lever 18 is turned upward to rotate the rotating body 12 in an arrow A direction (see FIGS. 2A and 2B and the like). The lever 18 is turned downward to rotate the rotating body 12 in an arrow B direction (see FIGS. 2A and 2B and the like).

The lever 18 is disposed at an “H” position (home position) as a shift position (second shift position). The lever 18 is turned upward from the “H” position to be disposed at an “R” position (reverse position) as a shift position (first shift position). The lever 18 is turned downward from the “H” position to be disposed at a “D” position (drive position) as a shift position (first shift position). The lever 18 is biased to the “H” position side from the “R” position and the “D” position. When action of an operating force on the lever 18 is released in a state where the lever 18 is operated to a position other than the “H” position, the lever 18 is turned (returned) to the “H” position by a biasing force.

A link 20 (see FIGS. 2A, 2B, 3A, and 3B) as a detection body constituting the link mechanism 14 is disposed on a front side of the rotating body 12, and the link 20 has a substantially columnar link shaft 20A as a detection shaft. An axial direction of the link shaft 20A is a front-rear direction, and the link 20 is supported so as to be rotatable about the link shaft 20A as a central axis.

A substantially U-shaped frame-shaped link frame 20B as a connected portion is integrally disposed at an intermediate portion of the link shaft 20A in a front-rear direction thereof. The link frame 20B protrudes upward and has an inside opened in a front-rear direction and upward. The connection shaft 16A of the rotating body 12 (piece 16) is inserted into the link frame 20B from above. The connection shaft 16A is fitted into the link frame 20B in a left-right direction and is relatively movable in an up-down direction with respect to the inside of the link frame 20B. When the rotating body 12 is rotated in the arrow A direction, the link frame 20B is rotated to a right side by rotation of the connection shaft 16A, and the link 20 is rotated in an arrow C direction (see FIGS. 2A and 2B and the like). When the rotating body 12 is rotated in the arrow B direction, the link frame 20B is rotated to a left side by rotation of the connection shaft 16A, and the link 20 is rotated in an arrow D direction (see FIGS. 2A and 2B and the like). A rotation radius of the link frame 20B at a contact position with the connection shaft 16A is smaller than a rotation radius of the connection shaft 16A at the contact position with the link frame 20B, and rotation (rotation angle) of the link 20 is amplified with respect to rotation (rotation angle) of the rotating body 12.

A fitting frame 20C having a substantially rectangular parallelepiped box shape is integrally disposed on a front side of the link shaft 20A. The inside of the fitting frame 20C is opened to a front side and a lower side, and a lower surface of a rear wall of the fitting frame 20C is inclined in a direction toward an upper side as it goes from a center in a left-right direction toward both outer sides in the left-right direction. An upper wall of the fitting frame 20C has a substantially C-shaped cross section. The inside of the fitting frame 20C has a substantially L-shaped cross section. An upper portion in the upper wall of the fitting frame 20C is extended in a left-right direction, and a right portion in the upper wall of the fitting frame 20C is extended downward and opened. A left wall and a right wall of the fitting frame 20C are separated from the upper wall of the fitting frame 20C and are inclined in a direction toward a lower side as it goes toward an outer side of the fitting frame 20C in a left-right direction thereof. Locking portions protrude at front end portions of the left wall and the right wall of the fitting frame 20C.

A substantially trapezoidal columnar magnet 22 (see FIGS. 3A and 3B) as a unit to be detected is fitted into the fitting frame 20C of the link 20 from a front side. A substantially L-shaped columnar fitting piece 22A is integrally disposed on an upper surface of the magnet 22. An upper portion of the fitting piece 22A is extended in a left-right direction, and a right portion of the fitting piece 22A is extended downward. The fitting piece 22A is fitted into the upper wall of the fitting frame 20C, and thus, movement of the fitting piece 22A in an up-down direction and a left-right direction with respect to the fitting frame 20C is locked. A rear surface of the magnet 22 abuts on a rear wall of the fitting frame 20C, and the locking portions of the left wall and the right wall of the fitting frame 20C are locked to a front surface of the magnet 22. Therefore, movement of the magnet 22 in a front-rear direction with respect to the fitting frame 20C is locked. As a result, the magnet 22 is fixed to the fitting frame 20C and integrally rotated with the link 20.

A lower surface of the magnet 22 is inclined in a direction toward an upper side as it goes from a center in a left-right direction toward both outer sides in the left-right direction. The left portion and the right portion of the lower surface of the magnet 22 are formed into a flat left parallel surface 22B and a flat right parallel surface 22C as parallel surfaces, respectively, and are disposed along a lower surface of the rear wall of the fitting frame 20C. The left parallel surface 22B of the magnet 22 and a right portion of the upper surface of the magnet 22 serve as first magnetic poles (for example, N poles), and the right parallel surface 22C of the magnet 22 and a left portion of the upper surface of the magnet 22 serve as second magnetic poles (for example, S poles). The magnet 22 generates a magnetic field (for example, see a magnetic field line M in FIG. 3B) therearound.

A detection substrate 24 (see FIGS. 2A and 2B) as a detection device is disposed below the magnet 22, and the detection substrate 24 is disposed perpendicularly to an up-down direction. A magnetic sensor 26 having a substantially rectangular plate shape as a detection unit is fixed to an upper surface of the detection substrate 24. The magnetic sensor 26 is disposed immediately below a lower surface of the magnet 22, and is disposed such that an upper surface thereof is parallel to a center of the lower surface of the magnet 22 in a left-right direction (boundary position between the left parallel surface 22B and the right parallel surface 22C) and the upper surface of the detection substrate 24. The magnetic sensor 26 has a planar detection surface 26A (magnetic field sensing surface) therein, and the detection surface 26A is disposed in parallel to an upper surface of the magnetic sensor 26. The magnetic sensor 26 detects a direction of a magnetic field generated by the magnet 22 on the detection surface 26A to detect a rotational position of the magnet 22.

Next, an operation of the present embodiment will be described.

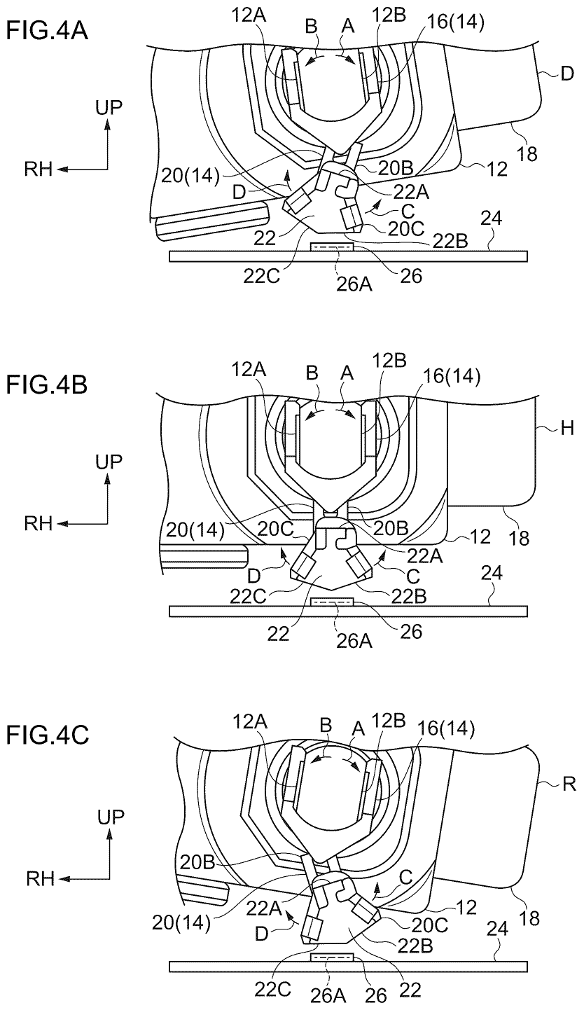

In the shift device 10 having the above structure, the lever 18 is turned to change a shift position of the lever 18. In addition, the lever 18 is turned to rotate the rotating body 12, whereby the link 20 and the magnet 22 are rotated to change a position of a lower surface of the magnet 22 facing the detection surface 26A of the magnetic sensor 26 in the detection substrate 24 (see FIGS. 4A to 4C). Furthermore, the magnetic sensor 26 detects a direction of a magnetic field generated by the magnet 22 on the detection surface 26A to detect a rotational position of the magnet 22, whereby a rotational position of the link 20, a rotational position of the rotating body 12, and a turning position of the lever 18 are detected, and a shift position of the lever 18 is detected.

Here, when the lever 18 is disposed at the “D” position, the left parallel surface 22B of the magnet 22 faces the detection surface 26A of the magnetic sensor 26 in parallel (see FIG. 4A). Furthermore, when the lever 18 is disposed at the “R” position, the right parallel surface 22C of the magnet 22 faces the detection surface 26A of the magnetic sensor 26 in parallel (see FIG. 4C). Therefore, when the lever 18 is disposed at the “D” position or the “R” position, a variation in a direction of a magnetic field of the magnet 22 on the detection surface 26A of the magnetic sensor 26 can be suppressed, detection accuracy of a rotational position of the magnet 22 by the magnetic sensor 26 can be increased, and detection accuracy of the “D” position and the “R” position of the lever 18 can be increased.

In addition, the left parallel surface 22B and the right parallel surface 22C of the magnet 22 serve as magnetic poles of the magnet 22. Therefore, when the lever 18 is disposed at the “D” position or the “R” position, a variation in the direction of the magnetic field of the magnet 22 on the detection surface 26A of the magnetic sensor 26 can be effectively suppressed, and detection accuracy of the rotational position of the magnet 22 by the magnetic sensor 26 can be effectively increased.

Furthermore, when the lever 18 is disposed at the “H” position, a center of the lower surface of the magnet 22 in a left-right direction, which is a center between the magnetic poles of the magnet 22, faces the detection surface 26A of the magnetic sensor 26 (see FIG. 4B). Therefore, when the lever 18 is disposed at the “H” position, a variation in the direction of the magnetic field of the magnet 22 on the detection surface 26A of the magnetic sensor 26 can be suppressed, detection accuracy of the rotational position of the magnet 22 by the magnetic sensor 26 can be increased, and detection accuracy of the “H” position of the lever 18 can be increased.

The piece 16 (connection shaft 16A) of the rotating body 12 and the link 20 (link frame 20B) constitute the link mechanism 14, and rotation is transmitted from the rotating body 12 to the link 20. Therefore, rotation can be transmitted from the lever 18 to the magnet 22 with a simple structure.

Furthermore, rotation of the link 20 is amplified with respect to rotation of the rotating body 12, and rotation of the magnet 22 is amplified with respect to turning of the lever 18. Therefore, a rotation amount of the magnet 22 with respect to a turning amount of the lever 18 can be increased, detection accuracy of a turning position of the lever 18 based on a rotational position of the magnet 22 can be increased, and detection accuracy of a shift position of the lever 18 can be increased.

Note that, in the present embodiment, one magnetic sensor 26 detects a magnetic field generated by the magnet 22. However, a plurality of magnetic sensors 26 may detect the magnetic field generated by the magnet 22.

Furthermore, in the present embodiment, the rotating body 12 and the link 20 are connected while constituting the link mechanism 14. However, the rotating body 12 and the link 20 may be connected while constituting a gear mechanism.

In addition, in the present embodiment, the lever 18 is biased to the “H” position side. However, the lever 18 may be biased to each shift position side.

Furthermore, in the present embodiment, the lever 18 (shift body) is turned. However, the shift body may be rotated about a central axis or slid (moved). When the shift body is slid, the shift body and the rotating body 12 may constitute a rack and a pinion, whereby the shift body may be slid to rotate the rotating body 12.

In addition, in the present embodiment, the shift device 10 is disposed in the steering column. However, the shift device 10 may be disposed in another portion (such as an instrument panel or a console) of the vehicle.

The whole of the disclosure of Japanese Patent Application No. 2022-33886 filed on Mar. 4, 2022 is incorporated herein by reference.

### REFERENCE SIGNS LIST

10 Shift device
14 Link mechanism
18 Lever (shift body)
22 Magnet
22B Left parallel surface (parallel surface)
22C Right parallel surface (parallel surface)
26 Magnetic sensor (detection unit)
26A Detection surface

1. A shift device comprising:
a shift body that is moved to change a shift position;
a magnet that has a parallel surface and that is moved by movement of the shift body; and
a detection unit that has a detection surface in which a position of the magnet facing the detection surface is changed by movement of the magnet and that detects a magnetic field generated by the magnet on the detection surface to detect a movement position of the magnet and to detect a shift position of the shift body, the parallel surface facing the detection surface in parallel when the shift body is disposed at a first shift position.

2. The shift device according to claim 1, wherein the parallel surface serves as a magnetic pole of the magnet.

3. The shift device according to claim 1, wherein, when the shift body is disposed at a second shift position, a center between magnetic poles of the magnet faces the detection surface.

4. The shift device according to claim 1, wherein movement of the magnet is amplified with respect to movement of the shift body.

5. The shift device according to claim 1, further comprising a link mechanism that transmits movement from the shift body to the magnet.

6. The shift device according to claim 1, further comprising a gear mechanism that transmits movement from the shift body to the magnet.

7. The shift device according to claim 1, wherein the magnet has a plurality of parallel surfaces, and the shift body is disposed at a plurality of first shift positions.
